(19) United States
(12) Patent Application Publication
(10) Pub. No.: US 2007/0127763 A1
(43) Pub. Date: Jun. 7, 2007

(54) Connecting arm between a microphone post and a base to allow the microphone post to be received in the base

(76) Inventor: Wu-Hong Hsieh, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,097

(22) Filed: Dec. 5, 2005

(51) Int. Cl. H04R 9/08

(52) U.S. Cl. 381/363; 381/361

(57) ABSTRACT

A connecting arm includes an L shaped body, a tube extending from a bottom of the body and having an opening defined in an end of the tube for communication with the base and a friction face formed on a top portion of the body and adapted to be sandwiched by a connector which is securely mounted on the friction face to slidably receive therein the microphone post such that the microphone post is axially aligned with the base and able to be received in the base for storage.

### BACKGROUND OF THE INVENTION

1. Field of the Invention

The present invention relates to a connecting arm, and more particularly to a connecting arm inbetween a microphone post and a base to allow the microphone post to be received in the base when the microphone post is not in use.

2. Description of Related Art

A conventional microphone support assembly is composed of a microphone post (50) for supporting thereon a microphone (not shown) and a base (60) pivotally connected to the microphone post (50) via a connector (70) which is securely and firmly mounted on free end of the base (60). The base (60) is able to stand on a surface by itself and thus is able to support the microphone post (50). The microphone post (50) is offset to the base (60) and is slidably received in the connector (70) so that the user is able to adjust the length extending out of the connector (70). Also, due to the pivotal connection between the connector (70) and the base (60), the pivotal movement of the connector (70) together with the microphone post (50) relative to the base (60) enables the user to adjust the angle of the microphone post (50) relative to the base (60). This kind of configuration fulfills the goal of supporting the microphone and the adjustment of the microphone. However, when the microphone support assembly is not in application and is to be stored, the microphone post (50) can only be retracted to a side of the base (60), which causes the entire volume large and due to the extension of the microphone post (50) from a side of the base (60), passersby are quite easily tripped by the microphone post (50).

To overcome the shortcomings, the present invention tends to provide an improved connecting arm to mitigate the aforementioned problems.

### SUMMARY OF THE INVENTION

The primary objective of the present invention is to provide a connecting arm sandwiched between the microphone post and the base to align the microphone post with the base so that the microphone post is able to be received in the base when the microphone post is not in use.

In one objective of the present invention, the connecting arm has a substantially L shape, which helps to align the microphone post with the base.

In yet another objective of the present invention, the connecting arm has a tube extending from a bottom of a body thereof so that the tube is able to be movably received inside the base.

A further objective of the present invention is that the connecting arm is provided with a friction face to enable the clamping device to engage with the friction face so as to fix the microphone post relative to the base.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the connecting arm of the present invention;

FIG. 2 is a perspective view showing the mounting of the connecting arm onto a microphone support assembly;

FIG. 3 is an exploded perspective view of the connector and the connecting arm;

FIG. 4 is a schematic front plan view showing that the clamping device is loosely connected to the friction face of the connecting arm to allow the connector to be pivot relative to the connecting arm;

FIG. 5 is a schematic front plan view showing that the clamping device is firmly connected to the friction face of the connecting arm to allow the connector to be fixed relative to the connecting arm;

FIG. 6 is an exploded perspective view showing alternative embodiment of the connector;

FIGS. 7A and 7B are schematic views showing the application of the connecting arm to enable the microphone post to be received in and extended out of the base; and

FIG. 8 is a side plan view showing a conventional microphone support assembly

### DETAILED DESCRIPTION OF THE PREFERRED EMBODIMENT

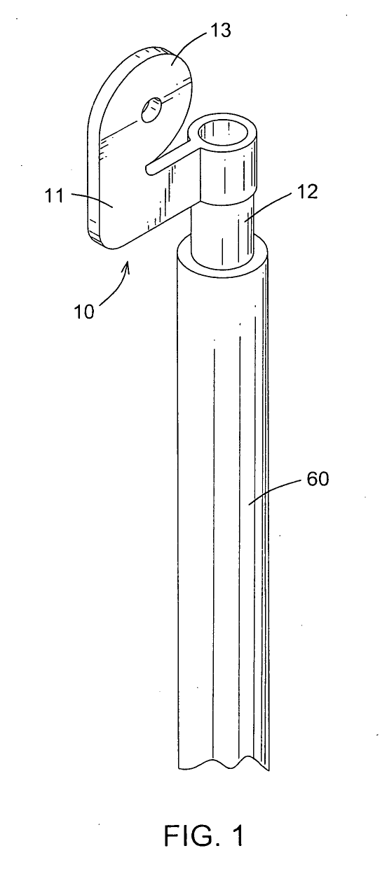

With reference to FIG. 1, it is noted that the connecting arm (10) in accordance with the present invention includes an L-shaped body (11), a tube (12) extending from a bottom of the body (11) and having an opening defined in a top end of the tube (12) and a friction face (13) formed on a top portion thereof. Preferably, a hole (not numbered) is defined through the friction face (13).

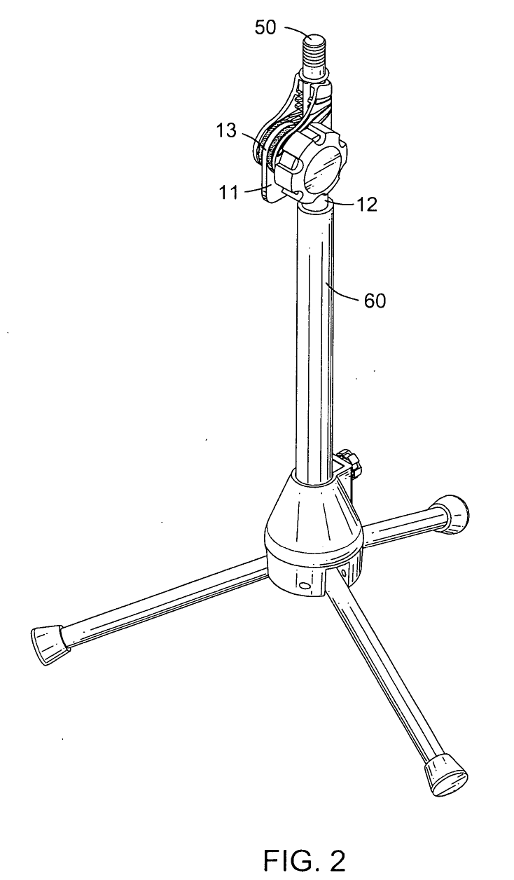

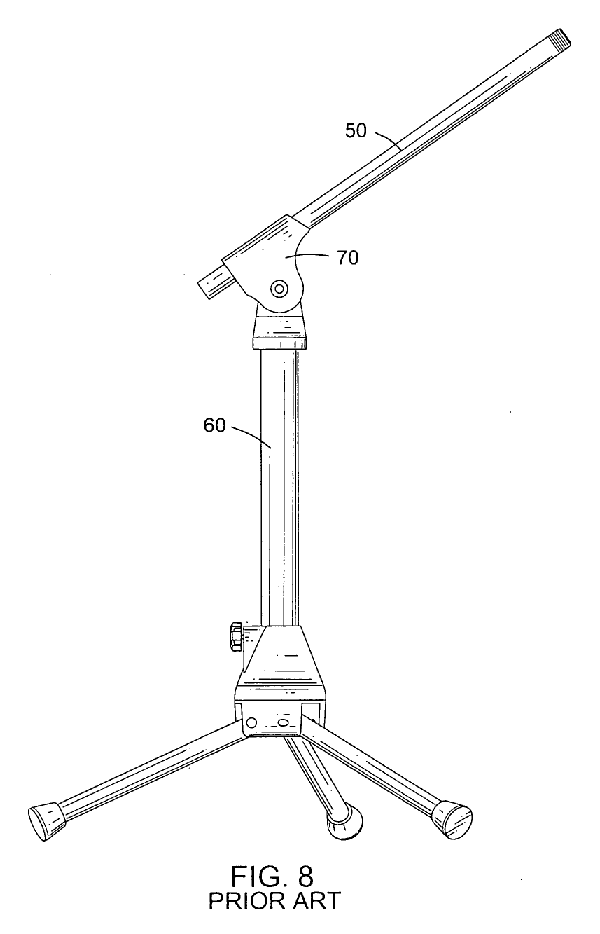

From the depiction of FIG. 2, it is noted that elements the same as those described in FIG. 8 are designated with the same numerals to simplify the description hereinafter. The tube (12) of the connecting arm (10) is extended into the base (60) and the friction face (13) is securely clipped by the connector (70) in which the microphone post (50) is slidably received.

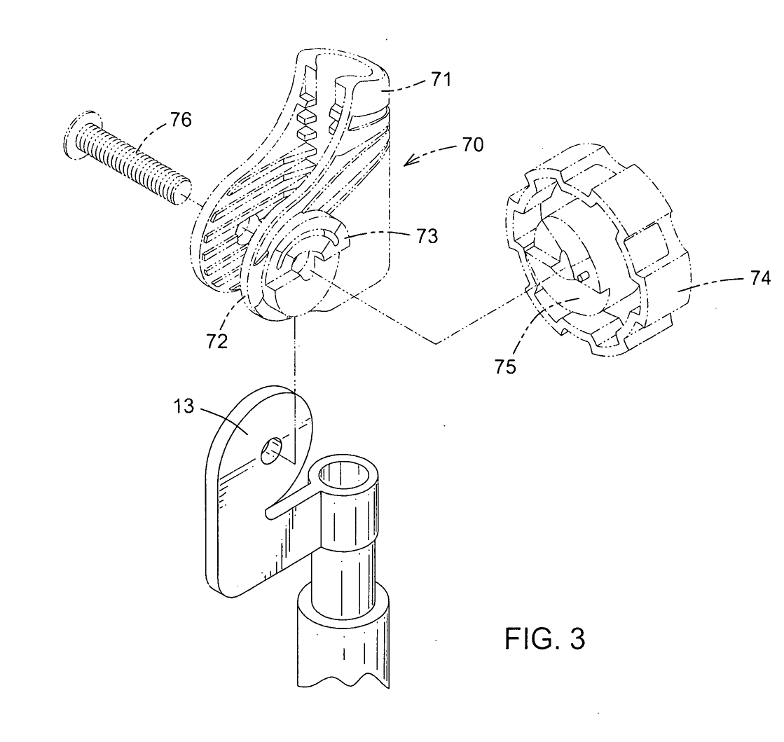

With reference to FIG. 3, the connector (70) in one embodiment is provided with a clamping device (71), which is composed of two clamping faces, a first wedged face (72) formed on one of the two clamping faces, a through hole (73) defined through the first wedged face (72) and the clamping faces, a knob (74) rotatably mounted on a side of the clamping device (71) and having a second wedged face (75) corresponding to the first wedged face (72) and a threaded bolt (76) extending through the clamping device (71) and into the knob (74).

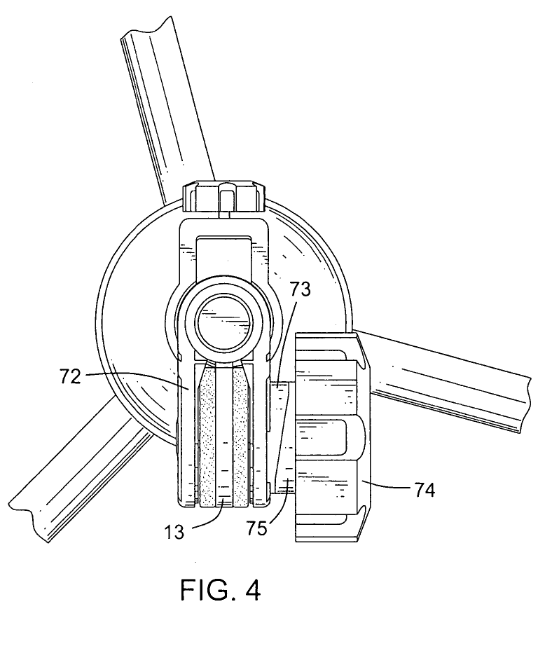

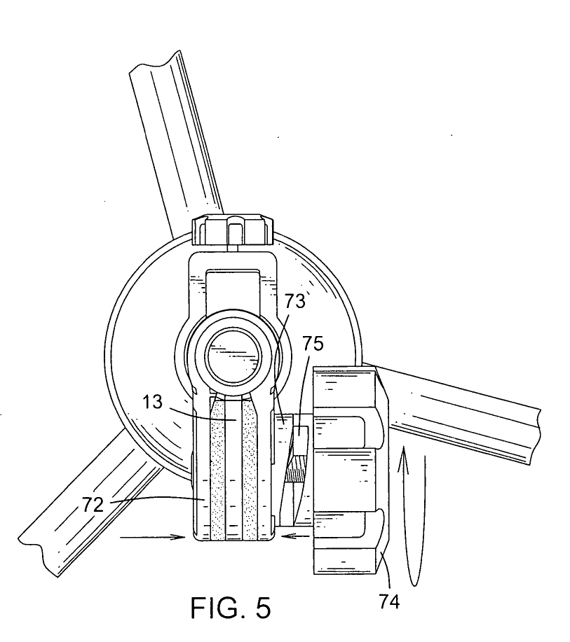

With reference to FIGS. 4 and 5 and still using FIG. 3 for reference, it is noted that when the connector (70) is assembled with the connecting arm (10) of the present invention, the friction face (13) of the connecting arm (10) is first placed between the two clamping faces of the clamping device (71). Then the threaded bolt (76) with a head is applied to extend through the clamping device (71), the friction face (13), the through hole (73) and into the knob (74) such that the friction face (13) is securely sandwiched between the two clamping faces of the clamping device (71) of the connector (70). Thereafter, from the engagement between the first wedged face (73) and the second wedged face (75), the user is able to control whether the connector (70) is able to pivot relative to the connecting arm (10) or not. That is, when the first wedged face (73) and the second wedged face (75) are complementarily engaged with one another, the connector (70) is able to pivot relative to the connecting arm (10). However, when the knob (74) is rotated to allow the second wedged face (75) to shift from complimentary engagement with the first wedged face (73) so as to have a phase difference therebetween, the two clamping faces of the clamping device (71) is forced to move toward the friction face (13) of the connecting arm (10), which fixes the clamping device (71) to the connecting arm (10). Thus the connector (70) is immovable relative to the connecting arm (10).

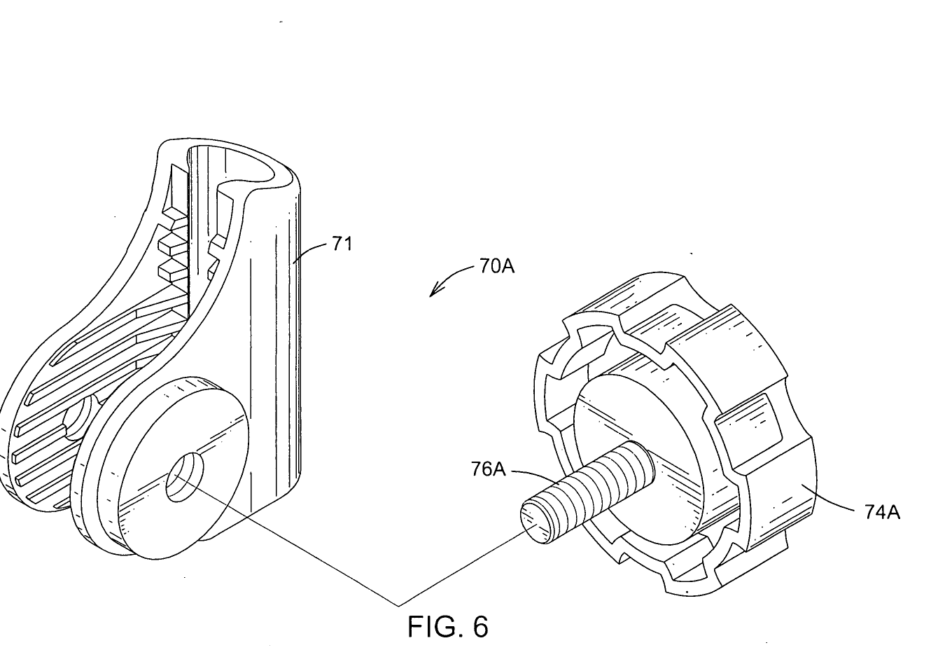

With reference to FIG. 6, it is noted that the connector (70) may include a clamping device (71) and a knob (74A) having a threaded bolt (76A) extending out of the knob (74A) to threadingly connect to the clamping device (71). That is, the securing force to force the two clamping faces to move toward the friction face (13) of the connecting arm (10) may have different forms and is not limited to the embodiments described.

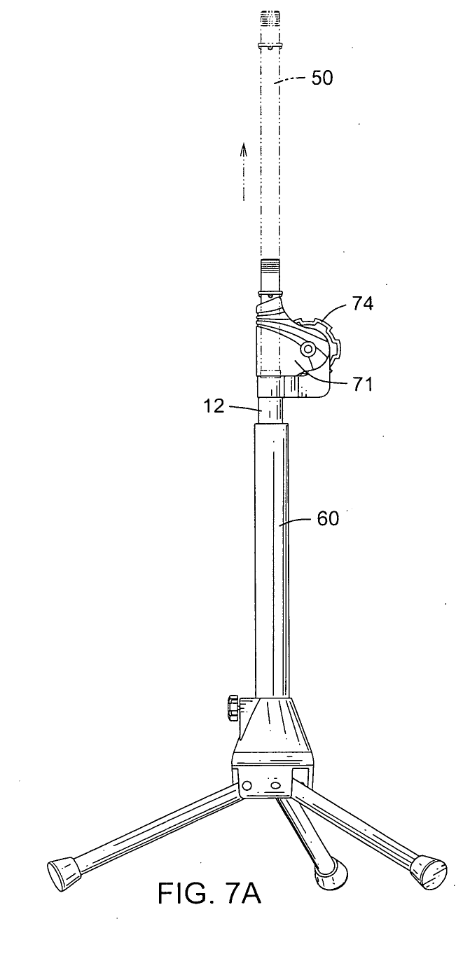

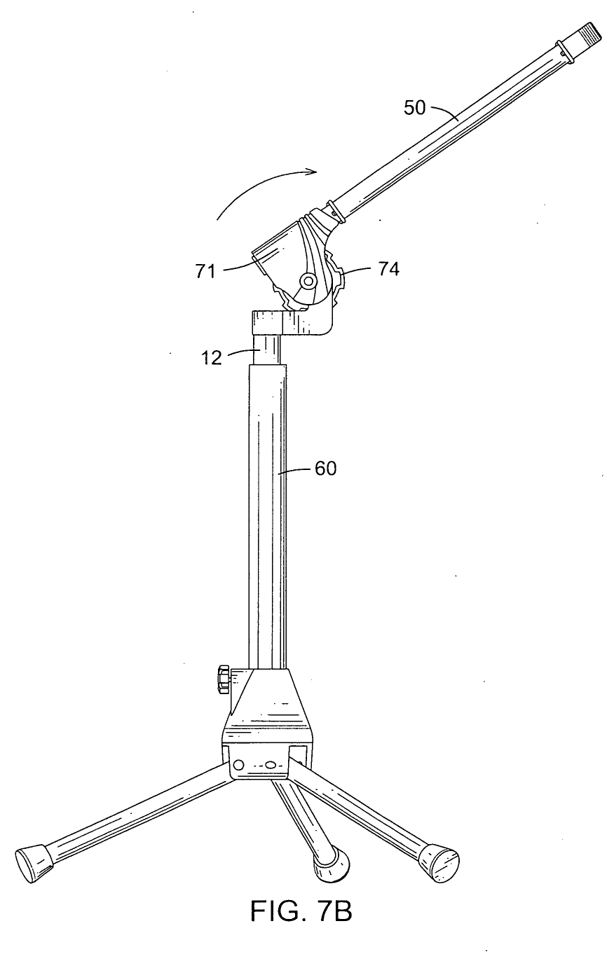

With reference to FIGS. 7A and 7B, the microphone post (50) is able to extend through the opening of the tube (12) and into the base (60) for storage due to the provision of the connecting arm (10) of the present invention to align axially the microphone post (50) and the base (60). But when the microphone support assembly is in application, the microphone post (50) has to be extended out of the base (60) as well as the tube (12). Then the user may use the knob (74) to adjust the engagement between the clamping device (71) and the connecting arm (10) to pivot the connector (70) relative to the base (60) and to slide the microphone post (50) relative to the connector (70).

From the previous description, it is noted that the connecting arm (10) of the present invention is able to align the microphone post (50) with the base (60) axially such that the microphone post (50) is able to be received in the base (60) to reduce the overall volume of the microphone support assembly. Based on the feature, the overall volume of the microphone support assembly is compact and easy to be handled with.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connecting arm in between a microphone post and a base standing on a surface to allow the microphone post to be slidably received in the base, the connecting arm comprising:
an L shaped body;
a tube extending from a bottom of the body and having an opening defined in an end of the tube for communication with the base; and
a friction face formed on a top portion of the body and adapted to be sandwiched by a connector which is securely mounted on the friction face to slidably receive therein the microphone post such that the microphone post is axially aligned with the base and able to be received in the base for storage.
